(19) United States
(12) Patent Application Publication
(10) Pub. No.: US 2008/0131644 A1
(43) Pub. Date: Jun. 5, 2008

(54) Fluororubber molded article, and rubber material and O-ring using the same

(75) Inventors: Takeshi Kuboyama, Hamamatsu-shi (JP); Naoya Kuzawa, Hamamatsu-shi (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, Minato-ku (JP)

(21) Appl. No.: 11/987,665

(22) Filed: Dec. 3, 2007

(30) Foreign Application Priority Data
Dec. 4, 2006 (JP) 2006-326688

(51) Int. Cl. B32B 1/00; C08F 14/18

(52) U.S. Cl. 428/66.4; 526/242

(57) ABSTRACT

The present invention provides a fluororubber molded article having a fluorinated surface, wherein the fluorinated surface has a ratio of the number of oxygen atoms to the number of fluorine atoms of 0.11 or less, and a ratio of the number of C—H bonds to the number of C—F₂ bonds is 1.0 or less, and wherein the fluororubber molded article shows a leak amount 3 minutes after initiation of a helium leak test of 1.0×10⁻¹² Pa·m³/sec or less.

### FIELD OF THE INVENTION

The present invention relates to a fluororubber molded article improved in surface characteristics, and particularly relates to a fluororubber molded article suitable for a semiconductor manufacturing apparatus, a semiconductor conveyance apparatus, a liquid crystal manufacturing apparatus, a vacuum instrument and the like.

### BACKGROUND OF THE INVENTION

Seal materials such as O-rings used in semiconductor manufacturing apparatus, semiconductor conveyance apparatus, liquid crystal manufacturing apparatus, vacuum instrument and the like have hitherto been required to have plasma resistance, heat resistance, cleanness, chemical resistance and the like, and fluororubber materials have been popularly used.

In general, a rubber material is liable to stick to a metal surface to be sealed, so that in an apparatus which is frequently opened and closed, the problem of inhibiting a normal operation of the apparatus tends to occur. Further, at the time of maintenance, the seal material adheres to the metal surface so strongly that it cannot be easily peeled off. When an attempt is made to forcibly peeled it off, there is a problem such that rubber powder falls down by rubbing to cause troubles in the apparatus. Such a problem of sticking to the metal surface as described above also similarly occurs in fluororubbers having low surface energy. In the above-mentioned apparatuses, the problem of sticking to the metal surface becomes remarkable because it is exposed to high vacuum and high temperature.

As techniques for preventing the fluororubber from sticking to the metal surface, there have been known (1) incorporation of an oil, (2) treatment for formation of a silicone reactive layer on the surface (for example, see patent document 1), (3) a treating method of impregnating the vicinity of the surface with a crosslinking agent, followed by heating to increase crosslinking density in the vicinity of the surface (for example, see patent document 2), (4) blending with a silicone rubber (for example, see patent document 3), (5) incorporation of a fluorocarbon resin powder filler (for example, see patent document 4), and the like.

However, the method of (1) suffers from the problems of contamination caused by oil exudation and decreased strength of the material itself. In the method of (2), the fluororubber material is used in a high-temperature environment of about 200° C. in many cases, so that amido and urethane bonds which bind the silicone molecules to each other or bind the silicone molecule to the rubber surface are thermally deteriorated to fail to exhibit non-stickiness. According to the method of (3), minute cracks are generated on the surface by surface curing, so that sealing properties are not satisfied in a high-vacuum region. The method of (4) also causes thermal deterioration of the silicone rubber, resulting in insufficient non-stickiness, and has disadvantages such as a decrease in strength of the fluororubber material, and the like. According to a simple filling method such as the method of (5), the number of the resin powder appearing on the surface layer is small, so that sufficient non-stickiness is not exhibited. When the filling amount of the resin powder is increased in order to solve this problem, this causes the problems of decreased elasticity and strength of the rubber material and deterioration in crosslink moldability.

Patent Document 1: JP-A-1-301725

Patent Document 2: JP-B-5-21931

Patent Document 3: JP-A-5-339456

Patent Document 4: Japanese Patent No. 3009676

### SUMMARY OF THE INVENTION

As described above, according to the conventional art, it has been difficult to impart non-stickiness to a fluororubber material used in a clean environment and in a severe environment of high temperature or high vacuum.

The invention has been made in view of the above-mentioned conventional problems, and an object thereof is to provide a fluororubber molded article having a decreased number of polar groups on a surface thereof, which contribute to sticking, and having lowered surface free energy; and also provides a rubber material and an O-ring using the same.

Other objects and effects of the invention will become apparent from the following description.

The present inventors have discovered that when a fluororubber molded article is fluorinated while allowing the ratio of the number of oxygen atoms to that of fluorine atoms and the ratio of the number of C—H bonds to that of C—F₂ bonds on the surface to be within the specific ranges, excellent non-stickiness such that it does not stick to a metal surface even when brought into contact with the metal in a high temperature environment is attained, and further discovered that the surface state does not vary for a long period of time to significantly improve durability as well, thus leading to completion of the invention.

That is, the invention relates to a fluororubber molded article described below, and a rubber material and an O-ring using the same.

(1) A fluororubber molded article having a fluorinated surface,

wherein the fluorinated surface has a ratio of the number of oxygen atoms to the number of fluorine atoms of 0.11 or less, and a ratio of the number of C—H bonds to the number of C—F₂ bonds of 1.0 or less, and

wherein the fluororubber molded article shows a leak amount 3 minutes after initiation of a helium leak test is 1.0×10⁻¹² Pa·m³/sec or less.

(2) The fluororubber molded article described in the above (1), which has a sticking force to a metal in an environment of 200° C. of 100 N (Newtons) or less.

(3) A rubber material used in a seal portion of a semiconductor manufacturing apparatus, a liquid crystal manufacturing apparatus or a vacuum instrument, or a semiconductor conveyance apparatus, which comprises the fluororubber molded article described in the above (1) or (2).

(4) An O-ring comprising the fluororubber molded article described in the above (1) or (2).

The fluororubber molded article of the invention is fluorinated so that the surface thereof has a specific composition. Accordingly, secondary bonds or Van der Waals forces become difficult to act between the fluororubber molded article and a metal surface. As a result, excellent non-stickiness is obtained, and moderate flexibility is also imparted to have such excellent sealing properties that the leak amount 3 minutes after initiation of a helium leak test is 1.0×10⁻¹² Pa m³/sec or less.

### BRIEF DESCRIPTION OF THE DRAWINGS

FIG. 1 is a graph showing the relationship between the first measured value of sticking force and the number ratio of [oxygen atoms/fluorine atoms] or the number ratio of [C—H bonds/C—F₂ bonds].

FIG. 2 is a chart of the helium leak amount measured.

### DETAILED DESCRIPTION OF THE INVENTION

The best mode for carrying out of the invention (hereinafter referred to as an embodiment) will be described below.

The fluororubber molded article of the invention is a fluororubber molded article fluorinated so that the ratio of the number of oxygen atoms to that of fluorine atoms on the surface becomes 0.11 or less and preferably 0.08 or less, and the ratio of the number of C—H bonds to that of C—F₂ bonds on the surface becomes 1.0 or less and preferably 0.5 or less. That is, the fluororubber molded article of the invention has a highly fluorinated surface.

A fluororubber molded article to be fluorinated herein is preferably a copolymer mainly comprising vinylidene fluoride and hexafluoropropylene. Examples thereof include but are not limited to Viton A manufactured by Dupont Elastomer Co., Ltd. and FE 5641Q manufactured by Sumitomo 3M Limited. There may be used a polymer obtained by copolymerizing a third component such as tetrafluoroethylene, propylene, ethylene or perfluoro-alkyl vinyl ether, in addition to vinylidene fluoride and hexafluoropropylene, or a polymer having a crosslinking site of a peroxide of iodine, bromine or the like. A crosslinking system is not particularly limited.

A fluorination treatment method is not particularly limited, but preferred is a method of allowing the molded article to stand in a high-concentration fluorine gas atmosphere, or a method of irradiating the molded article with fluorine-based plasma by means of a high-density plasma irradiation apparatus such as a parallel plate RIE apparatus, an ICP plasma irradiation apparatus, a helicon wave plasma irradiation apparatus, an ECR plasma irradiation apparatus or a surface wave plasma irradiation apparatus. Particularly preferred are a method of allowing the molded article to stand in a high-concentration fluorine gas atmosphere, a method of irradiating the molded article with plasma from which ions have been removed with a trap mechanism by using a high-density plasma irradiation apparatus, and a method of utilizing a remote plasma.

In the method of allowing the molded article to stand in a high-concentration fluorine gas atmosphere, parameters such as the gas concentration, the gas flow rate, the standing time, the degree of vacuum attained in a chamber, the degree of vacuum at the time of treatment and the heating temperature of a substrate rubber are appropriately set to optimum values to conduct treatment, depending on the volume of the chamber, the kind of fluororubber, the number of treating samples and the sample size. Further, also in the high-density plasma irradiation apparatus, in addition to the above-mentioned parameters, the plasma density is appropriately set to an optimum value to conduct treatment, depending on the system of plasma generation. When the treatment conditions are too excessive, carbon black and silica usually incorporated into the fluororubber drop out to impair purity. Further, under some conditions, cracks occur on the rubber surface to fail to express sealing properties. In the case of insufficient treatment, the desired non-stickiness is not expressed.

In the fluororubber molded article of the invention, the sticking force to a metal is preferably 100 N (Newtons) or less and more preferably 70 N or less, for example, in an environment of 200° C. Moreover, a surface state thereof does not vary for a long period of time, and the sticking force does not increase even when used for a long period of time.

Further, the fluororubber molded article of the invention also has such excellent sealing properties that the leak amount 3 minutes after initiation of a helium leak test is 1.0×10⁻¹² Pa·m³/sec or less and preferably 5.0×10⁻¹³ Pa·m³/sec or less.

The fluororubber molded article of the invention having such characteristics is suitably used as a seal member or constituent material of an apparatus or instrument used in a severe environment of high temperature and vacuum, such as a semiconductor manufacturing apparatus, a semiconductor conveyance apparatus, a liquid crystal manufacturing apparatus, a vacuum instrument, a food manufacturing apparatus, a food conveyance instrument, a food storage instrument or a medical part. Specifically, it can be used as an O-ring for a semiconductor manufacturing apparatus such as a wet washing apparatus, a plasma etching apparatus, a plasma ashing apparatus, a plasma CVD apparatus, an ion injection apparatus or a sputtering apparatus, a constituent material of a wafer conveyance instrument which is ancillary equipment of these apparatus, and the like.

### EXAMPLES

The fluororubber molded article according to the present invention will be illustrated in greater detail with reference to the following examples and comparative examples, but the invention should not be construed as being limited thereto.

### (Preparation of Fluororubber Molded Article)

Twenty parts of MT carbon, 3 parts of magnesium oxide, 6 parts of calcium hydroxide and 0.5 part of a fatty acid ester were incorporated into 100 parts of a binary copolymer, G7801 (containing bisphenol A as a crosslinking agent) manufactured by Daikin Industries, Ltd., and kneaded on an open roll. The resulting mixture was heat treated at a temperature of 170° C. for 10 minutes to perform primary crosslinking, and then, heat treated at 230° C. for 24 hours to perform secondary crosslinking, thereby obtaining a sheet-shaped fluororubber molded article of 100 mm×100 mm×6 t.

### Example 1

The above-mentioned fluororubber molded article was set in a chamber of a surface wave plasma irradiation apparatus, and irradiation was performed under the following conditions for 3 minutes to prepare a sample.

Output: 3,000 W

Gas species: CF₄

Gas flow rate: 300 cc/min

Base material temperature: 30° C.

Degree of vacuum at the time of treatment: 6 Pa

### Example 2

A sample was prepared in the same manner as in Example 1 with the exception that the degree of vacuum upon the plasma irradiation was changed to 50 Pa to prepare a sample.

### Example 3

A sample was prepared in the same manner as in Example 1 with the exception that the degree of vacuum upon the plasma irradiation was changed to 133 Pa.

### Comparative Example 1

A sample was prepared in the same manner as in Example 1 with the exception that the degree of vacuum upon the plasma irradiation was changed to 500 Pa.

### Comparative Example 2

A sample was prepared in the same manner as in Example 1 with the exception that the degree of vacuum upon the plasma irradiation was changed to 1,000 Pa.

### Comparative Example 3

The above-mentioned fluororubber molded article as it is was taken as a sample (untreated).

### Comparative Example 4

In place of the plasma irradiation, a surface of the above-mentioned fluororubber molded article was impregnated with a crosslinking agent, followed by heating to perform crosslinking, thus preparing a sample.

### Comparative Example 5

A silicone reactive layer was formed on the surface of the above-mentioned fluororubber molded article to prepare a sample.

### Comparative Example 6

Using a parallel plate RIE apparatus, excessive treatment was conducted to the above-mentioned fluororubber molded article at 150 W for 2 hours to prepare a sample.

### Surface Composition Analysis

Using an X-ray photoelectron spectroscopic analyzer (XPS: XSAM800cpi) manufactured by Shimadzu Corporation, atoms and molecules constituting a surface of each sample and their state of chemical bonding were analyzed under the following conditions to determine the ratio of the number of oxygen atoms to that of fluorine atoms and the ratio of the number of C—H bonds to that of C—F₂ bonds.

Analysis area: 5 mm×10 mm (width)

Degree of vacuum: 10⁻⁶ Pa

X-ray cathode voltage: 15 kV

X-ray cathode current: 10 mA

### Measurement of Sticking Force

A test piece having a thickness of 6 mm and a diameter of 10 mm was cut out from each sample, and compressed by 25% in a thickness direction from both sides with disc-shaped compression plates of stainless steel (SUS316L) having a thickness of 2 mm and a diameter of 90 mm. The test piece in this state was placed in a gear oven at 200° C. and allowed to stand for 22 hours. Then, after cooled, the above-mentioned metal compression plates were vertically pulled at a rate of 10 mm/sec with an autograph to measure the maximum load at that time. The measurement was carried out three times repeatedly.

### Measurement of Helium Leak Amount

Using a Helium leak detector UL500 (detection sensitivity: 1.0×10⁻¹³ Pa·m³/sec) manufactured by LEYBOLD, the variation of the leak amount with time was determined. Test conditions were as follows:

Sample shape: AS568-214

Temperature: room temperature

Rubber compression rate: 25%

Measuring time: 1 hour

Helium pressure: 0.1 MPa

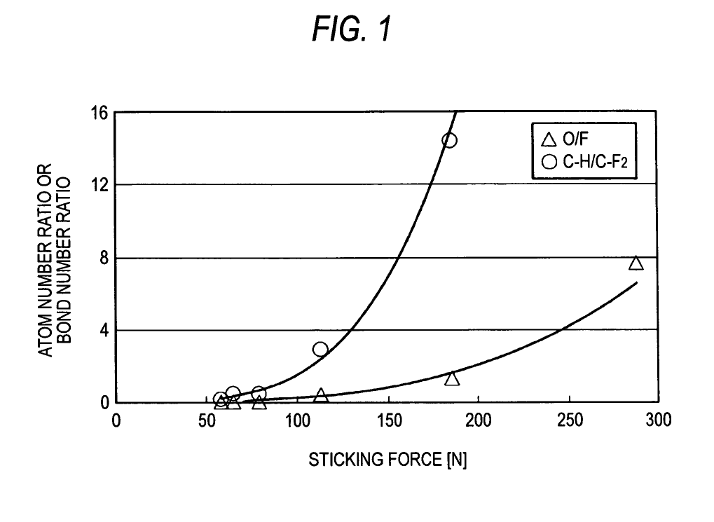

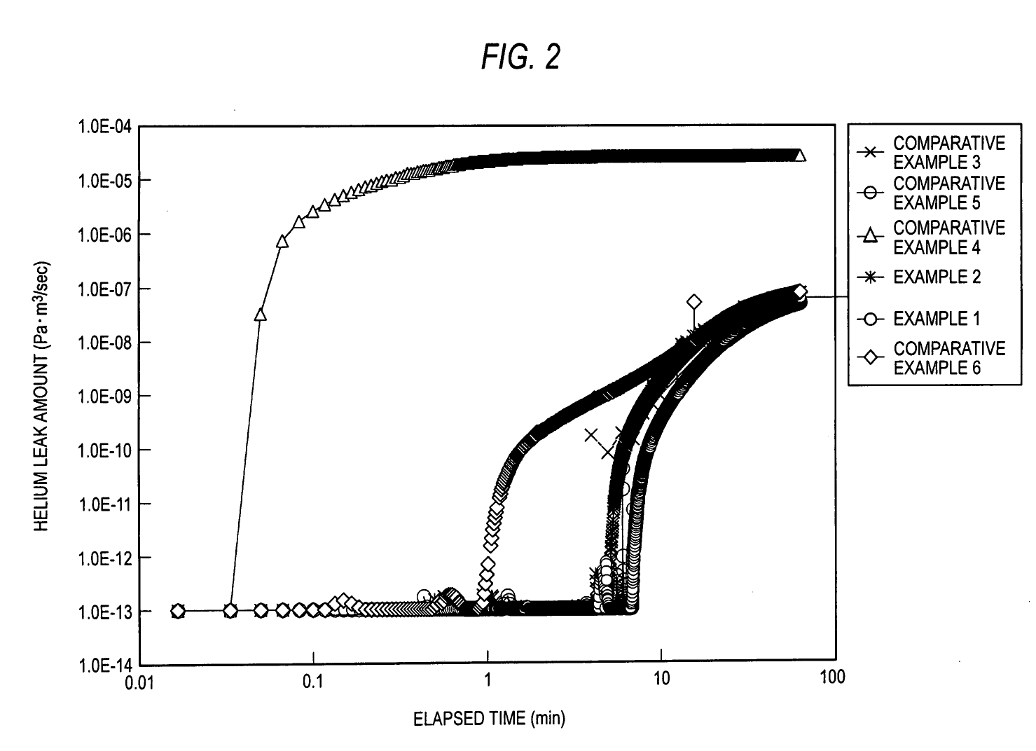

The measurement results of the above are shown in Table 1, FIG. 1 and FIG. 2. In Table 1, the sticking force data are first and third measured values, and the helium leak amount is a measured value 3 minutes after helium was allowed to flow. Further, FIG. 1 is a graph showing the relationship between the first measured value of sticking force and the ratio of the number of oxygen atoms to that of fluorine atoms or the ratio of the number of C—H bonds to that of C—F₂ bonds, and FIG. 2 is a chart of the helium leak amount measured.

TABLE 1

| | | | Helium | [O/F] | [C—H/C—F₂] |
|---|---|---|---|---|---|
| | Sticking Force | | Leak | Atom | Bond |
| | (N) | | Amount | Number | Number |
| | First | Third | (Pa · m³/sec) | Ratio | Ratio |
| Example 1 | 58 | 56 | 1.0 × 10⁻¹³ | 0.05 | 0.2 |
| Example 2 | 65 | 66 | 1.0 × 10⁻¹³ | 0.08 | 0.4 |
| Example 3 | 79 | 81 | 1.0 × 10⁻¹³ | 0.08 | 0.4 |
| Comparative | 113 | 110 | 1.0 × 10⁻¹³ | 0.44 | 2.9 |
| Example 1 | | | | | |
| Comparative | 186 | 190 | 1.0 × 10⁻¹³ | 1.37 | 14.4 |
| Example 2 | | | | | |
| Comparative | 288 | 292 | 1.0 × 10⁻¹³ | 7.70 | 20.0 |
| Example 3 | | | | | |
| (Untreated) | | | | | |
| Comparative | 66 | 66 | 2.2 × 10⁻⁵ | 1.26 | 7.2 |
| Example 4 | | | | | |
| Comparative | 53 | 200 | 1.0 × 10⁻¹³ | 37.66 | ∞ |
| Example 5 | | | | | |
| Comparative | 143 | 145 | 4.3 × 10⁻¹⁰ | 0.08 | 0.7 |
| Example 6 | | | | | |

As shown in Table 1 and FIG. 1, the sticking force of the samples of Examples 1 to 3 according to the invention is about one-fifth of that of the untreated sample (Comparative Example 3), which reveals that non-stickiness to metal is improved. Further, the samples of Examples 1 to 3 have small changes between the first and third measured values of sticking force, compared to the sample with the silicone reactive layer formed (Comparative Example 5), which shows that the samples of Examples 1 to 3 are also excellent in durability. Furthermore, it is revealed that the helium leak amount of the samples of Examples 1 to 3 is small, compared to the sample increased in crosslinking density in the vicinity of the surface thereof by impregnating it with the crosslinking agent (Comparative Example 4) and the sample subjected the excessive treatment by using the parallel plate RIE apparatus (Comparative Example 6).

While the present invention has been described in detail and with reference to specific embodiments thereof, it will be apparent to one skilled in the art that various changes and modifications can be made therein without departing from the spirit and scope thereof.

This application is based on Japanese Patent Application No. 2006-326688 filed Dec. 4, 2006, and the contents thereof are herein incorporated by reference.

What is claimed is:

1. A fluororubber molded article having a fluorinated surface,
wherein the fluorinated surface has a ratio of the number of oxygen atoms to the number of fluorine atoms of 0.11 or less, and a ratio of the number of C—H bonds to the number of C—F₂ bonds is 1.0 or less, and
wherein the fluororubber molded article shows a leak amount 3 minutes after initiation of a helium leak test of 1.0×10⁻¹² Pa·m³/sec or less.

2. The fluororubber molded article according to claim 1, which has a sticking force to a metal in an environment of 200° C. of 100 N (Newtons) or less.

3. A rubber material comprising the fluororubber molded article according to claim 1.

4. An O-ring comprising the fluororubber molded article according to claim 1.
